(19) United States
(12) Patent Application Publication
(10) Pub. No.: US 2016/0101852 A1
(43) Pub. Date: Apr. 14, 2016

(54) Annular ducted lift fan VTOL aircraft

(71) Applicant: Yun Jiang, Toronto (CA)

(72) Inventor: Yun Jiang, Toronto (CA)

(21) Appl. No.: 14/510,734

(22) Filed: Oct. 9, 2014

(51) Int. Cl. B64C 29/00

(52) U.S. Cl. CPC B64C 29/0016

(57) ABSTRACT

The invention is an annular ducted lift fan system for a VTOL type aircraft. In detail, the invention comprises an annular duct, a lift fan set, engines, a central fuselage, a peripheral wing, and means for pneumatic coupling or mechanic coupling of engines and the lift fan set. The lift fan set is mounted in the annular duct and powered by the engines through pneumatic coupling or mechanic coupling. The annular duct is opened with the lift fan set working to provide high lift efficiency in VTOL mode and transition mode and is closed off to reduce drag in cruise mode.

### REFERENCES CITED

### U.S. Patent Documents

| | | | |
|---|---|---|---|
| 3,972,490 | August 1976 | Zimmermann et al. | 244/12 B |
| 4,469,294 | September 1984 | Clifton | 244/12.3 |
| 4,474,345 | October 1984 | Musgrove | 244/53R |
| 4,791,783 | December 1988 | Neitzel | 60/262 |
| 5,170,963 | December 1992 | Beck | 244/12.2 |
| 5,209,428 | May 1993 | Bevilaqua et al. | 244/12.3 |
| 5,275,356 | January 1994 | Bolinger et al. | 244/12.3 |
| 5,312,069 | May 1994 | Bollinger et al. | 244/12.3 |
| 5,320,305 | June 1994 | Oatway et al. | 244/12.3 |
| 5,407,150 | April 1995 | Sadleir | 244/12.4 |
| 5,507,453 | April 1996 | Shapery | 244/12.5 |
| 6,561,456 B1 | May 2003 | Devine | 244/12.1 |
| 7,267,300 B2 | September 2007 | Heath et al. | 244/12.3 |
| 7,510,140 B2 | May 2009 | Lawson et al. | 244/12.5 |
| 7,677,502 B2 | March 2010 | Lawson et al. | 244/207 |
| 8,220,737 B2 | July 2012 | Wood et al. | 244/12.3 |
| 8,336,806 B2 | December 2012 | Dierksmeier | 244/12.3 |
| 2013/0140404 | June 2013 | Parks | 244/23A |

### TECHNICAL FIELD

The present invention relates to vertical take-off and landing (VTOL) aircraft and, more specifically, relates to VTOL aircraft wherein annular-ducted lift-fans are used to provide powered lift while in hovering mode and transition mode.

### BACKGROUND

The primary drawback to conventional fixed wing aircraft is that they must have a runway to create sufficient airflow over the wings such that they may take off and land. Much effort has been directed towards the development of aircraft capable of vertical take-off or landing which are not restricted to airport runways but can land and take-off from any relatively small open area.

There are four types of successful and practical VTOL aircraft so far. They are helicopter, vectored jet aircraft, tiltrotor, and ducted lift-fan aircraft. These aircraft provide solutions to this problem, but also have some disadvantages.

Helicopters have rotary wing capable of vertical flight and hover, but they often have relatively slow forward speeds as the rotating blades create a large aerodynamic drag. A helicopter has a limited forward speed of less than 200 Knots due to compressibility effects on the rotor blade tips when the blades rotate at the speed of sound. Furthermore, the reaction of the rotation of its main rotor requires the use of a tail rotor rotating about a horizontal axis. Loss of function of the tail rotor is generally fatal to the airworthiness of the helicopter. Helicopters achieve horizontal flight by cyclic control of the rotor blade pitch, and control ascent and descent by collectively control the blade pitch. These lead to complex rotor control systems which are difficult and costly to maintain, and which require considerable pilot training and skill. The large exposed rotor blades are also vulnerable to strikes and dangerous to persons in the vicinity of the aircraft on the ground.

Vectored jet aircraft vector the engine exhaust from one or more turbofan engines downward to create lift. Once airborne, this type of aircraft gradually transitions the thrust aft until a forward airspeed sufficient to support the aircraft is reached, at which point the aircraft is wing-borne and conventional aerodynamics may take over. Such an aircraft is exemplified by jet aircraft the AV-8A Harrier V/STOL aircraft. The Harrier utilizes a turbofan engine for both hover and cruise propulsion. The fan provides significant trust for vertical lift in hover, but its correspondingly large frontal area increases the drag of the aircraft and limits its maximum speed to just barely above supersonic speed. Also, the jet turbines must produce exhausting air at extremely high speed and pressure to develop the required amount of thrust for vertical and horizontal flight. The nozzles are designed for efficient high speed forward thrust but are very inefficient in vertical lift mode; accordingly much greater power input is required for vertical lift than would otherwise be the case. Because of the high speed and force of exhausting air, take off and landing pads must be specially prepared so as not to be damaged. A relatively large clearance area must be provided about the aircraft to avoid the exhaust gas overturning objects that are not secured to the ground. The gas usually also have a temperature higher than 800° F., which may cause damage to surfaces such as runways, aircraft carrier decks, and natural terrain.

The tilt rotor concept, found in the V-22 Osprey aircraft, uses large diameter propellers powered by two cross-shafted turboshaft engines. Its disc loading is higher than a helicopter, but lower than a turbofan and, thus is efficient in the vertical flight modes. However, the large propellers limit the top speed to about 300 Knots at sea level due to compressibility effects on the propeller tips. Another problem with tiltrotors involves stability control difficulties. Particularly, turbulent rotational flow on the propeller blades may occur in descent and cause a vortex-ring state. The vortex-ring state causes unsteady shifting of the flow along the blade span, and may lead to roughness and loss of aircraft control. Also, the propellers have a large diameter and may strike the landing surface when the engines are still fully forward.

The last successful known approach to VTOL aircraft is the use of ducted lift fan or fans mounted in the airframe for developing vertical trust aligned with the aircraft center of mass. Horizontal thrust is developed either by deflecting the vertical thrust once take off has been achieved, or by operating a separate horizontal thruster. The lift fans may be gas driven or shaft driven by turbofan engines. While these aircraft often use very high disc loading fans, they are still more efficient than pure jet variants. An exemplary lift-fan aircraft is the Ryan XV-5, which was developed during the 1960s and flown successfully in 1968. The XV-5 used a pair of General Electric J-85 turbojet engines and three lift fans for controlled flight. Installed in each wing was a 62.5″ diameter fan to provide the majority of the thrust, with a smaller fan in the nose to provide some lift as well as pitch trim. For vertical liftoff, jet engine exhaust was diverted to drive the lift-fan tip turbines via a diverter valve. The core engines provided a total thrust of 5,300 pounds in forward flight mode, but could generate a total lift thrust of 16,000 pounds via the lift fans in hover mode. Using the lift fans provides a 200% increases in the total thrust, a clearly advantageous feature for vertical takeoff and landing aircraft. The recent development of this kind of aircraft is the Lockheed Martin F-35B joint strike fighter. A lift fan incorporated in fuselage is coupled to the turbofan engine by means of a drive shaft to augment the basic engine thrust for V/STOL operation. The idea was patented in U.S. Pat. No. 5,209,428 assigned to Lockheed Co. in 1993.

The ducted fans so far are all circular duct or its variants with a central inlet. The fans are submerged in the fuselage or wings. This design not only limits the size of fans due to the constraint of fuselage and wing size but also increases drag because the wings containing the fans have to be made relatively thick to maintain enough depth of fan ducts. The thick wings create unacceptable drag during forward flight. However if the thickness of the wings is made much smaller than the diameter of the fan ducts, the benefits of the duct will be reduced and the vertical thrust produced by the fans will be limited. Because of the relatively small size, the circular ducted lift fans thus far are all high disc loading in order to provide sufficient vertical thrust to raise the aircraft off the ground.

According to the momentum theory of ducted fans, high disc loading means higher power required to lift the aircraft, thus leading to low lift efficiency. To lower disc loading and increase lift efficiency, the fan area has to be increased. However, the space in the conventional aircraft for circular ducted fan is limited. Like Ryan XV-5A, not only incorporating lift fan in the large relatively thick wings creates unwanted drag during forward flight but also the wing size is not enough to contain larger low disc loading circular fans. Other designs, such as a huge circular lift fan in the center of the aircraft or a plurality of small circular ducted fans about the aircraft, suffer from other problems, such as difficult layout for fuselage, thick wing, and increased complexity, which make them unpractical so far.

It is therefore desirable to provide a solution that increases lift fan area and lift efficiency while keeping all the benefits of ducted fan and also avoid the drawbacks of the conventional VTOL aircraft, such as slow cruise speed, dangerous exposed rotor blades, hot downward high speed and pressure exhausting air, poor stability, etc. In the present invention, this is achieved through a novel annular ducted lift fan system shaft-driven or gas-driven by forward turbofan engines.

It is a primary object of the present invention to provide a lift system for VTOL aircraft having improved lift efficiency in the takeoff, landing and transition modes.

It is another primary object of the present invention to provide a design for VTOL aircraft having high efficiency in both hover and level flights.

### SUMMARY OF THE INVENTION

The present invention discloses a lift system for VTOL aircraft. In detail, the invention relates to aircraft comprising an annular ducted lift fan set mounted between the central fuselage and the peripheral wing. The lift fan set includes two counter-rotating fans that are pneumatic or mechanic coupled in the hover mode to the turbofan engines mounted in the peripheral wing of the aircraft. Controllable upper shutters or aperture and lower louvers are used to close off the annular duct during forward flight and to control the airflow through the outlet during transition flight. The surfaces of the closed duct become part of the blended-wing-body of the aircraft to provide aerodynamic lift during forward flight. The annular duct includes curved inlet lips, which are smoothly connected with the upper surfaces of the fuselage and the peripheral wing, and diffused outlet to maximize duct lift and increase lift efficiency.

Briefly, the present invention uses a large annular duct to replace the conventional circular duct of lift fan system. The main differences between the traditional circular duct and the annular duct are: 1. with the fuselage in the center, the annular duct can be made much larger around the fuselage, thus the fan area is greatly increased to realize low disc loading and high lift efficiency that is comparable to helicopter rotor; 2. meanwhile, the larger diameter of the annular duct does not reduce the duct effect.

Combining the annular ducted lift fan with forward turbofan engines provides a perfect VTOL aircraft that can fly faster, be safer and highly efficient in both hover and level flight. The numerical simulations using ANSYS FLUENT 14.5 demonstrate that the aircraft incorporating annular ducted lift fan has higher lift efficiency and may fly faster than helicopters and tiltrotors based on aerodynamic drag prediction. The smooth transition from vertical take-off to cruise flight only needs a little extra forward thrust to overcome a low peak of drag. This article is published in Aerospace, September 2015, 2(4): 555-580 (http ://www.mdpi.com/2226-4310/2/4/555).

The novel features which are believed to be characteristic of the invention, will be better understood from the following description in connection with the accompanying drawings in which the presently preferred embodiment of the invention is illustrated by way of example. It is to be expressly understood, however, that the drawings are for purposes of illustration and description only and are not intended as a definition of the limits of the invention.

DESCRIPTION OF THE DRAWINGS

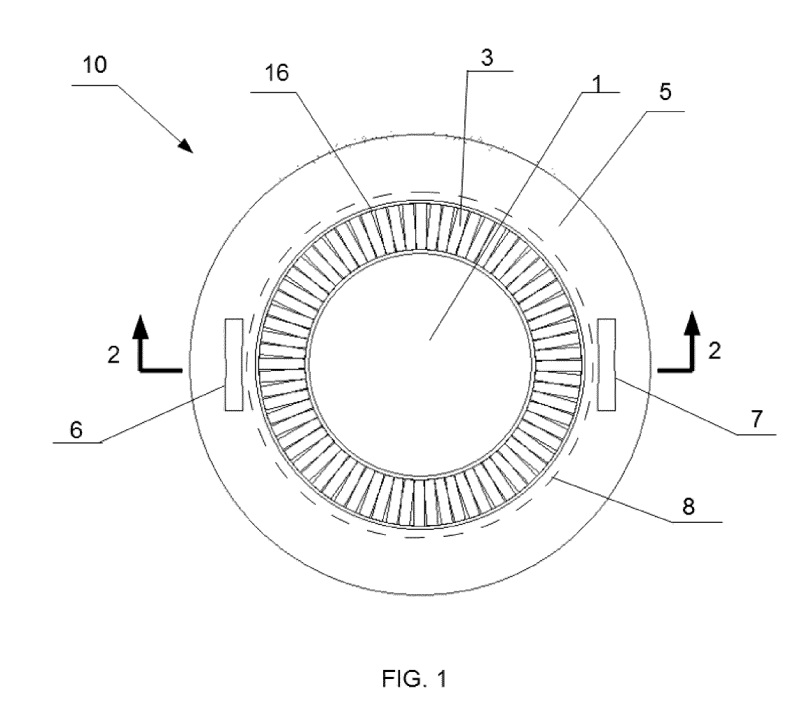

FIG. 1 illustrates a top view of an annular ducted lift fan aircraft with the duct opened (aperture or shutters not shown).

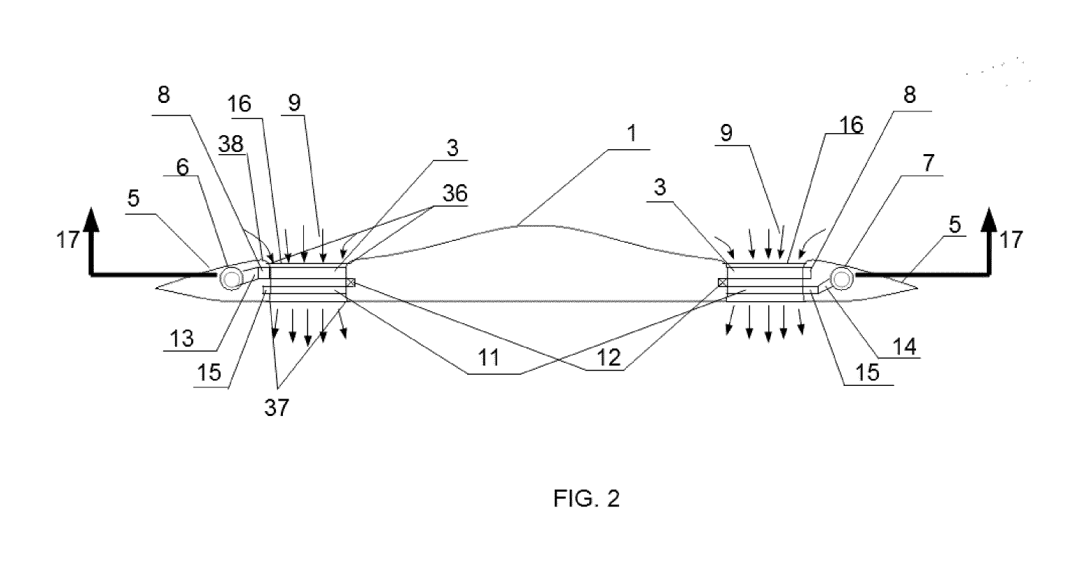

FIG. 2 illustrates a cross sectioned view of plane “2-2” of FIG. 1.

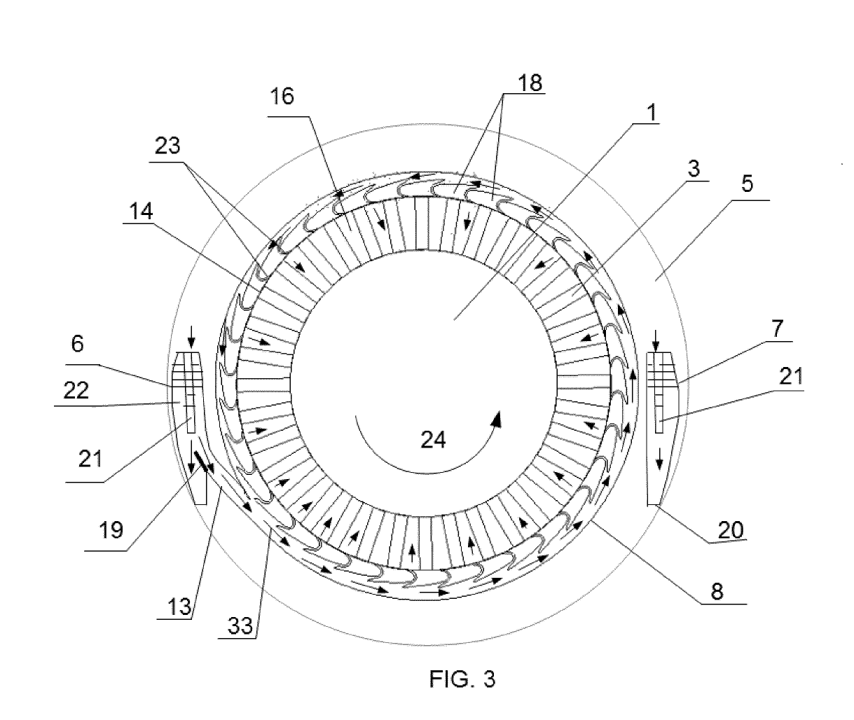

FIG. 3 illustrates a cross sectioned view of plane “17-17” of FIG. 2.

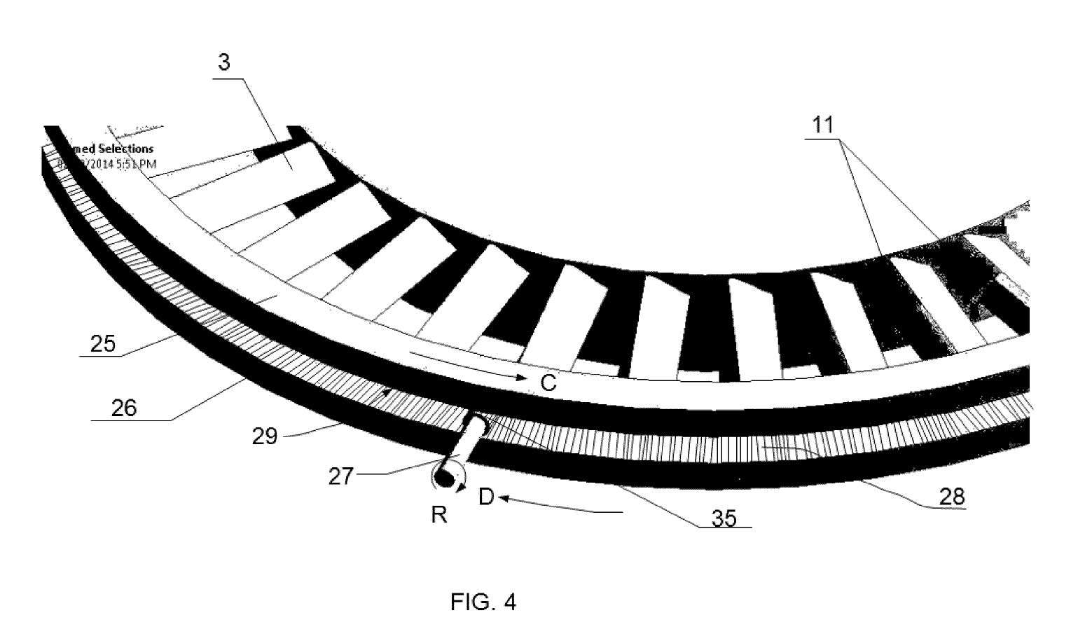

FIG. 4 illustrates a perspective view of a split-torque face gear system.

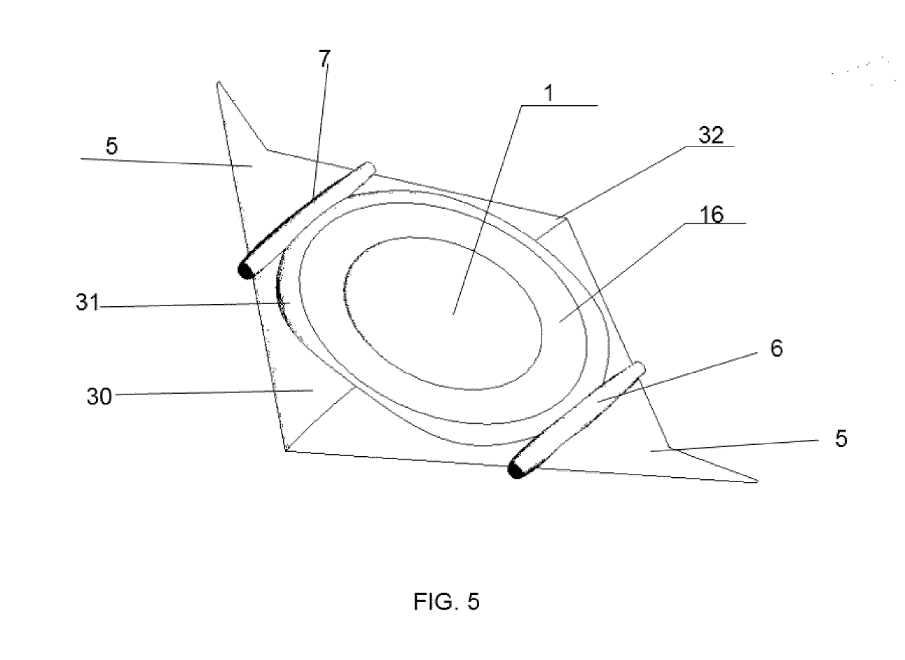

FIG. 5 illustrates drags of the aircraft increases with cruise speed at different angle of attack.

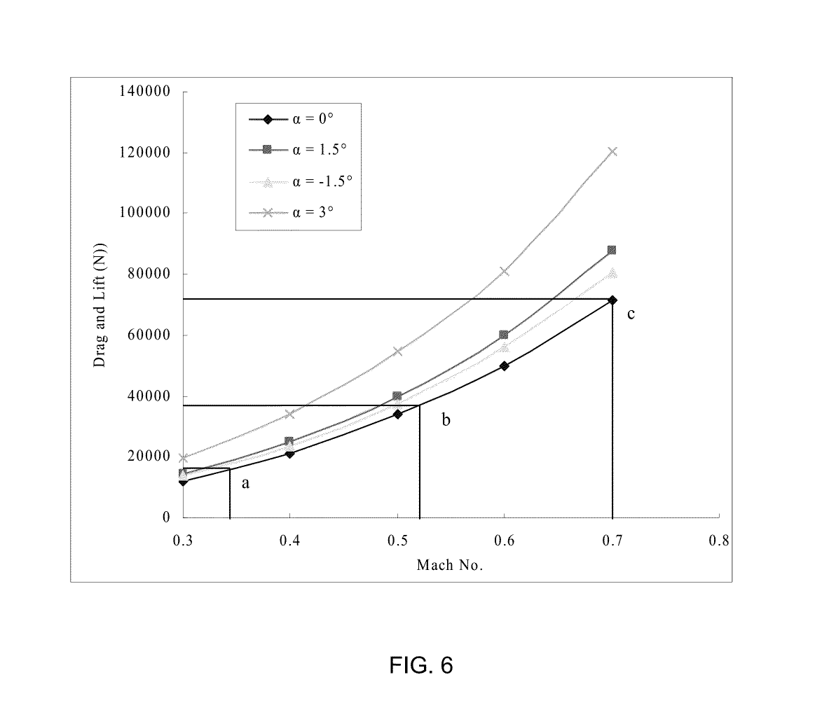

FIG. 6 illustrates a perspective view of a rhombic shaped annular ducted lift fan aircraft with the duct closed off by aperture or diaphragm.

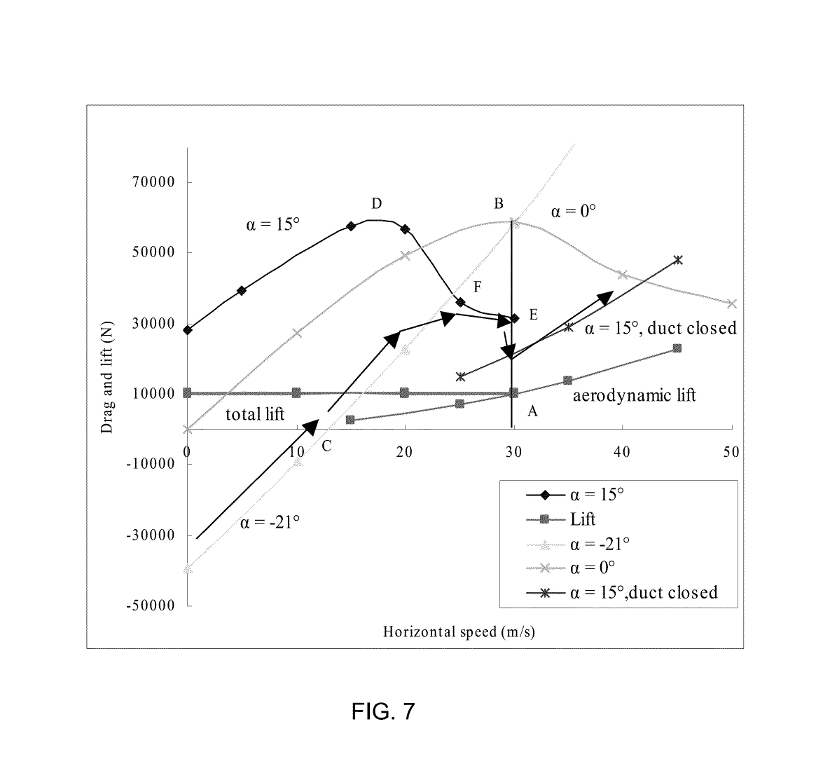

FIG. 7 illustrates net drags and lifts of the aircraft at different angle of attack in transition mode.

### DETAILED DESCRIPTION

The invention relates to aircraft with annular ducted lift fan system capable of efficient vertical takeoff and landing and horizontal flight. Referring now to the figures, and more particularly to FIG. 1, aircraft according to a first embodiment of the present invention is designated in its entirely by reference number 10. The aircraft 10 has a central fuselage 1, an annular duct 16 in which a lift fan set 3 is mounted, a peripheral wing 5, and two turbofan engines 6, 7. For gas-driven mode, a rectangular-shaped gas chamber 8 is also shown. The annular duct is completely opened with the shutters or aperture and louvers removed. Although the aircraft 10 may have other sizes without departing from the scope of the present invention, in one embodiment the aircraft has a peripheral wing diameter 20 meters, annular duct diameters 10 and 14 meters, fan blade length 2 meters, and depth of duct 1 meter, in order to compare with the rotor diameter 14.64 meters and blade length 7.32 meters of the Boeing AH-64E Apache helicopter. The weight of the aircraft 10 is also the maximum weight of the Apache 10.433 tons.

As shown in FIG. 2, the lift fan set has two counter-rotating fans upper fan 3 and lower fan 11 that are coupled by face gear set 12 to counter rotate at the same speed. The two fans 3,11 are powered by exhaust gases from different turbofan engines 6,7 respectively through gas ducts 13,14 to tip turbines in the rectangular-shaped gas chambers 8,15. Because the two fans are coupled to counter rotate, in the case of engine failure, one engine is capable of providing balanced power for both fans to ensure safe landing. The pitch angles of the blades of the two fans are adjusted so that the two fans produce the same moment to offset each other. Although the lift fan set has two counter-rotating fans here in the present embodiment, the two fans can also be uncoupled, or it may have other number of fans, such as one fan with airflow deflector or stator in the annular duct, without departing from the scope of the present invention.

FIG. 3 illustrates pneumatic coupled tip turbine for gas-driven mode. Exhaust from engine core 21 and bypass duct 22 of turbofan engine 6 is diverted by an internal gate or valve 19 to gas duct 13 and gas chamber 8. The exhaust gases 33 flow along the rectangular-shaped gas chamber 8 in a counterclockwise direction and exit from the discharge ports 23 to the annular fan duct 16. The discharge ports 23 are disposed between the turbine blades 18 on the inner wall 14 of the chamber 8. The inner wall 14 is fixed to and rotates with the fan blades 3 and their tip turbine blades 18. The airflow 33 causes pressure difference on the two surfaces of the tip turbine blades 18 and pushes the turbine and fan to rotate in a counterclockwise direction 24. The tip turbine and gas chamber can also be other types, such as disclosed in U.S. Pat. No. 5,275,356, without departing from the scope of the present invention.

The lift fan system can also be shaft-driven. FIG. 4 illustrates a shaft-driven split-torque system comprising an upper face gear 25 and a lower face gear 26, which can be found in detail in U.S. Pat. No. 7,267,300. Each face gear has a face plane 28,29 with teeth on it. The upper and lower face gears 25,26 are driven by a floating input shaft 27, which drives a corresponding pinion 35. The input pinion 35 drives the opposing face gears 25,26 in opposite directions C, D during operation. The split-torque drive systems are lighter and more space efficient than traditional systems because of their load bearing and structural qualities. For shaft-driven mode, the turbofan engines also need to be modified to be convertible between turboshaft mode and turbofan mode of operation. The details of convertible engines can be found in U.S. Pat. No. 4,791,783 and 5,209,428.

Referring particularly to FIGS. 2 and 3, in vertical takeoff mode, exhaust gases from engines 6,7 are completely diverted by internal valve 19 to gas ducts 13,14 to drive fans 3,11 to counter rotate. The rotation of the fans induces airflow 9 sucked from above of the inlet of the annular duct 16 to exit from the diffused outlet 37. The air is pushed downward by the fans and the duct to generate upward thrust, which lifts the aircraft off the ground.

According to the numerical simulation results using ANSYS FLUENT (Jiang, et al. CFD study of an annular-ducted fan lift system for VTOL aircraft. Aerospace 2015, 2(4), 555-580; doi: 10.3390/aerospace2040555), the counter-rotating fans produce a straight non-swirling and non-converged downstream airflow. Almost half of the total thrust comes from duct thrust, which comes from the low pressure induced by the airflow on the inlet lips 36 and upper surface of peripheral wing 38. Among the duct thrust, about half comes from the inlet lips 36 and the other half comes from the peripheral wing. With the maximum weight 10.433 tons, lift efficiency (power loading) of the annular ducted lift fan system is T/P=4.25 kg/kw, while the lift efficiency of the Apache helicopter at the maximum weight is 3.89 kg/kw. The power for the aircraft to lift the maximum weight is predicted to require 2455 kw, and if ground effect is considered and the distance from the aircraft to the ground is 10 meters, the power is only 1880 kw, much lower than the simulated power of the Apache 2685 kw (the actual output power of the Apache is 2676 kw, supposing the mechanic transmission efficiency is 0.9).

The reasons why the annular-ducted fan can save energy are two-fold: 1) elimination of rotor tip vortex loss, wake swirling loss, and wake coning loss. The duct not only eliminates fan tip vortex, but also prevents the downstream flow from contraction. 2) additional duct lift. Beside the fan thrust, there is an additional duct lift caused by the low pressure on the duct inlet lips and upper surfaces of fuselage and peripheral wing, which can be almost as much as the fan thrust. The additional duct lift helps reduce the required fan thrust, thus reduce the drag on fan blades and the corresponding power required to run the fan. It is known that conventional circular ducted fan is more efficient than unducted fan or propeller, so the result that annular ducted fan is more efficient than rotor is not surprising.

The numerical simulations also show aerodynamic drag increases with velocity in horizontal flight when the duct is closed off (FIG. 5). When the drag increases to equal the engine thrust, the aircraft reaches the maximum speed. With 15.7 kN jet thrust, the maximum speed reaches 0.35 Ma (428 km/h, FIG. 5 spot a). Suppose the propulsive efficiency at this moment is 0.7, the jet power at this point is 2676 kw, which is the power of the Apache. While the maximum speed of the Apache is only 293 km/h, this speed (410 km/h) is 46% faster than the Apache. At this point, the lift is 131 kN, enough to carry the maximum weight 10,433 kg of the Apache. The configuration of the aircraft can be easily slightly modified (not so cambered) to reduce the lift to equal the weight without increasing the drag so that the aircraft can fly at the maximum speed in the minimum drag mode (at 0 degree angle of attack).

If the jet thrust increases to 36.3 kN, the maximum speed will reach 0.52 Ma (625 km/h, FIG. 5 spot b). Suppose the propulsive efficiency 0.7, the jet power at this point is 9180 kw, which equals the power of the V-22 osprey. This speed is 25% faster than the maximum speed of the Osprey 509 km/h.

The reason why a ducted lift-fan aircraft may fly faster than a helicopter or tiltrotor is that the compressibility effects on the rotor blade tips and rotor drag are eliminated and replaced by the aerodynamic surface drag because the duct is closed off by an aperture and louvers during horizontal flight. The surfaces of the aperture and louvers, as part of the blended-wing-body, provide aerodynamic lift for the aircraft.

Without the limits of rotor drag, the speed of the aircraft can increase further if higher thrust turbofan jet engines are equipped. To reach the speed of 0.7 Ma (857 km/h), the aircraft will need jet thrust 72.3 kN (FIG. 5 spot c). The lift at this point is 448 kN.

The annular ducted lift fan aircraft can also be other configurations rather than the above circular flying saucer shape without departing from the scope of the invention. FIG. 6 shows a rhombic shaped annular ducted lift fan aircraft. The aircraft has a central fuselage 1, a closed annular duct 16, a peripheral wing 5, a forward end 30, an aft end 32, two turbofan engines 6,7, and a conjunctive part 31 joining the annular duct 16 and the peripheral wing 5. Shutters or an aperture or a diaphragm and louvers close off the annular duct. The aircraft can also have traditional steering components such as ailerons, flaps, elevators, spoiler, slats, stabilizers, a rudder, etc (not shown). The rhombic shape maybe flies faster and is easier to control.

Low disc loading ducted lift fan introduces tremendous momentum drag during transition from vertical take off mode to cruise mode. Momentum drag is generally caused by a directional change of the airflow going through the lift fan. To achieve successful transition, the forward speed must reach a certain level in order to gain sufficient aerodynamic lift. As shown in FIG. 7, the minimum speed for the first embodiment of the present invention is 30 m/s at angle of attack 15 degrees (FIG. 7 spot A). To approach to this speed at angle of attack 0 degree and meanwhile maintain the lift, the drag increases with speed and forms a high peak at spot B, which needs 67 kN forward jet thrust to overcome. The peak exists because the momentum drag increases with the forward speed and the rotational speeds of fans, while the rotation speeds of fans needed to maintain the lift decreases with the forward speed. If the aircraft starts at −21 degrees angle of attack, because the lift fan system generates a forward force and causes a negative net drag, it can easily reach the speed of 13 m/s without additional forward jet thrust (spot C), but after that point the drag increases rapidly. The aircraft still needs about high forward thrust 63 kN to reach the speed of 30 m/s. If the aircraft starts at angle of attack 15 degrees, because the lift fan system generates a backward force and causes a positive net drag at forward speed 0 m/s, there is also a high peak of drag at the speed of 18 m/s (spot D), but after that point the drag decreases rapidly.

Therefore, the best way to achieve efficient transition seems: 1. Rise up at angle of attack 0 degree; 2. Change the angle of attack to −21 degrees and fly forward without additional forward jet thrust; 3. When the speed reaches about 13 m/s (spot c), continue to fly with additional forward jet thrust; 4. When the speed reaches about 23 m/s (spot F), change the angle of attack to 15 degrees, slow down the rotational speeds of the fans and continue to fly with additional forward jet thrust and reach the speed of 30 m/s (spot E); 5. Gradually Stop the lift fan and closes off the duct; 6. Continue to fly with aerodynamic lift. The net drag increases along the arrows in FIG. 7. In this way, the peak of momentum drag is much lower (near spot F), which only needs about 35 kN forward thrust to overcome. For vertical landing, the aircraft can start to reduce the forward speed at angle of attack 15 degrees, then open the duct and start the lift fan, and then change the angle of attack to 0 degree to land.

The attitude control can be performed through changing the direction of the thrust from the two jet engines respectively. Thrust vectoring can also be used to offset the nose up pitching moment and rolling moment during the transition.

While the invention has been described with reference to particular embodiments, it should be understood that the embodiments is merely illustrative as there are numerous variations and modifications which may be made by those skilled in the art. Thus, the invention is to be construed as being limited only by the spirit and scope of the appended claims.

I claim:

1. A VTOL aircraft with an annular ducted lift fan system comprising:
an annular duct including curved inlet lips and a diffused outlet;
an annular lift fan set;
a central circular fuselage;
a peripheral wing;
engines;
means for pneumatic coupling or mechanic coupling of said lift fan set and said engines;
various configurations including circular, rhombic, triangular, etc.

2. The aircraft as set forth in claim 1 wherein said annular lift fan set can include two counter-rotating fans (vertically, horizontally or parallel positioned) or one fan with airflow deflector or stator in said annular duct.

3. The aircraft as set forth in claim 1 wherein said peripheral wing can be different shape, such as circular, rhombic, triangular, etc.

4. The aircraft as set forth in claim 1 wherein said engines can be one, two, or more, and include turbofan engine, turbojet engine, turbopropeller engine, turboshaft engine, piston engine, electric engine, etc.

5. The aircraft as set forth in claim 1 wherein said pneumatic coupling means said lift fan set is gas-driven by exhaust gases from said jet engines.

6. The aircraft as set forth in claim 1 wherein said mechanic coupling means said lift fan set is shaft-driven by drive shafts powered by said engines.

7. The aircraft as set forth in claim 1 wherein said annular duct is closed off by shutters, aperture, and louvers during forward flight to generate aerodynamic lift and reduce drag.

8. The aircraft as set forth in claim 1 has higher lift efficiency and forward propulsive efficiency compared with the same fan area conventional circular ducted fan aircraft.

9. An annular ducted lift fan system comprising:
an annular duct including curved inlet lips and a diffused outlet;
an annular lift fan set;
engines;
means for pneumatic coupling or mechanic coupling of said lift fan set and said engines;

10. The system as set forth in claim 9 wherein said annular lift fan set can include two counter-rotating fans or one fan with airflow deflector or stator in said annular duct.

11. The system as set forth in claim 9 wherein said engines can be one, two, or more, and include turbofan engine, turbojet engine, turbopropeller engine, turboshaft engine, piston engine, electric engine, etc.

12. The system as set forth in claim 9 wherein said pneumatic coupling means said lift fan set is gas-driven by exhaust gases from said jet engines.

13. The system as set forth in claim 9 wherein said mechanic coupling means said lift fan set is shaft-driven by shaft powered by said engines.

14. The system as set forth in claim 9 wherein said annular duct is closed off by shutters, aperture, and louvers during forward flight to generate aerodynamic lift and reduce drag.

15. The system as set forth in claim 9 has higher lift efficiency and forward propulsive efficiency compared with the same fan area conventional circular ducted fan system.
